(19) United States
(12) Patent Application Publication
(10) Pub. No.: US 2014/0022763 A1
(43) Pub. Date: Jan. 23, 2014

(54) DISPLAY DEVICE

(71) Applicant: Sony Corporation, Tokyo (JP)

(72) Inventors: Hiroaki Matsui, Tokyo (JP); Kotaro Shima, Kanagawa (JP)

(21) Appl. No.: 13/938,658

(22) Filed: Jul. 10, 2013

(30) Foreign Application Priority Data
Jul. 19, 2012 (JP) 2012-160206

(51) Int. Cl. G02B 5/02

(52) U.S. Cl. CPC G02B 5/0273
USPC 362/97.1

(57) ABSTRACT

A display device includes a display with a display surface on which to display images, optical sources acting as a backlight to output light to the display, a diffuser panel disposed so as to face the optical sources, diffusing the light output from the optical sources, and a support pin disposed on the side opposite to the display across the diffuser panel. The support pin is contactable with the diffuser panel, maintains the position of the diffuser panel, and has a wide-width surface and a narrow-width surface that differ in width in two directions perpendicular to an alignment direction in which the display and the diffuser panel are aligned. The optical sources and the support pin are disposed alongside in a direction perpendicular to the alignment direction, and the narrow-width surface of the support pin faces the optical source at the shortest distance.

### BACKGROUND

The present disclosure relates to the field of technology for a display device. Specifically, the present disclosure relates to the field of technology by which a wide-width surface and a narrow-width surface are formed on a support pin, the narrow-width surface faces an optical source at the shortest distance to suppress the appearance of a shadow on a diffuser panel and suppress the occurrence of unevenness in the brightness on a display, and the high rigidity of the support pin is ensured.

The display device for a television set, a personal computer, or the like may include a display with a display surface on which to display images, an optical source that acts as a backlight to output light to the display, and a diffuser panel that diffuses the light output from the optical source.

In this type of display device, the light output from the optical source is diffused by the diffuser panel and incident on the display. Because the light diffused by the diffuser panel is incident on the display, the occurrence of unevenness in the brightness on the display is suppressed.

In the above display device, a plurality of support pins may be disposed in the rear of the diffuser panel so as to maintain the position of the diffuser panel (for example, see Japanese Unexamined Patent Application Publication No. 2011-34956).

The support pins are attached to a back chassis or the like disposed in the rear of the diffuser panel, and the tips of the support pins may come into contact with the rear surface of the diffuser panel. The support pins suppress deformation (deflection) in the diffuser panel and maintain the position of the diffuser panel. When the position of the diffuser panel is maintained, the optical distance from the optical source to the diffuser panel is kept constant, thereby ensuring excellent optical performance.

In addition, when the support pins suppress deformation in the diffuser panel, vibration in the front-back direction is suppressed, thereby preventing damage to optical sheets and the display disposed in the front of the diffuser panel.

### SUMMARY

However, in the display device with the support pins as described in Japanese Unexamined Patent Application Publication No. 2011-34956, the support pins are in the same space as the optical source in the rear of the diffuser panel and therefore block the light output from the optical source. When the support pins block the light, shadows of the support pins may appear on the diffuser panel and the brightness on the display may partially decrease, possibly causing unevenness in the brightness.

In particular, if an optical source with high directivity, such as a light emitting diode (LED), is used, shadows of the support pins are likely to appear on the diffuser panel due to the high directivity of the optical source.

In addition, there has been a trend in recent years that an amount of light output from one optical source such as a light emitting diode is increasing and, accordingly, the number of optical sources is decreasing. When the number of optical sources decreases, differences in the brightness in the sections on the display are likely to occur, and unevenness in the brightness is further likely to occur.

It is possible to decrease the thickness of a support pin in order to suppress the appearance of a shadow. In this case, however, the rigidity of the support pin may be lowered, possibly resulting in a loss of the excellent support pin function of suppressing deformation in the diffuser panel and maintaining the position of the diffuser panel.

It is desirable to provide a display device that suppresses the appearance of a shadow on a diffuser panel and suppresses the occurrence of unevenness in the brightness on a display while ensuring the high rigidity of support pins.

Firstly, according to an embodiment of the present technology, there is provided a display device including a display with a display surface on which to display images, a plurality of optical sources that act as a backlight to output light to the display, a diffuser panel that is disposed so as to face the plurality of optical sources and diffuses the light output from the optical sources, and a support pin that is disposed on the side opposite to the display across the diffuser panel, is contactable with the diffuser panel, and maintains the position of the diffuser panel. The support pin has a wide-width surface and a narrow-width surface that differ in width in two directions perpendicular to an alignment direction in which the display and the diffuser panel are aligned. The plurality of optical sources and the support pin are disposed alongside in a direction perpendicular to the alignment direction, and the narrow-width surface of the support pin faces the optical source at the shortest distance.

Therefore, in the display device, an amount of light output from the optical sources that is blocked by the support pin is reduced and a certain thickness of the support pin is ensured.

Secondly, in the display device described above, it is preferable that two narrow-width surfaces are formed so as to face in opposite directions, where each of the two narrow-width surfaces is the above narrow-width surface, and the support pin is disposed between two optical sources.

When the two narrow-width surfaces are formed so as to face in opposite directions and the support pin is disposed between the two optical sources, the two narrow-width surfaces face the two optical sources, respectively.

Thirdly, in the display device described above, it is preferable that the support pin is disposed in the center between the two optical sources.

When the support pin is disposed in the center between the two optical sources, an amount of light incident on the two narrow-width surfaces is equalized.

Fourthly, in the display device described above, it is preferable that a tip surface, which is part of an external surface of the support pin and located at the end on the diffuser panel side, is formed in a convex curved surface shape on the diffuser panel side.

When the tip surface, which is part of the external surface of the support pin and located at the end on the diffuser panel side, is formed in a convex curved surface shape on the diffuser panel side, the tip surface formed in a curved surface shape comes into contact with the diffuser panel as the support pin comes into contact with the diffuser panel.

Fifthly, in the display device described above, it is preferable that the external surface of the support pin is formed in a curved surface shape.

When the external surface of the support pin is formed in a curved surface shape, a portion with partially low rigidity is less likely to be generated in the support pin.

A display device according to an embodiment of the present technology includes a display with a display surface on which to display images, a plurality of optical sources that act as a backlight to output light to the display, a diffuser panel that is disposed so as to face the plurality of optical sources and diffuses the light output from the optical sources, and a support pin that is disposed on the side opposite to the display across the diffuser panel, is contactable with the diffuser panel, and maintains the position of the diffuser panel. The support pin has a wide-width surface and a narrow-width surface that differ in width in two directions perpendicular to an alignment direction in which the display and the diffuser panel are aligned. The plurality of optical sources and the support pin are disposed alongside in a direction perpendicular to the alignment direction, and the narrow-width surface of the support pin faces the optical source at the shortest distance.

Therefore, when light is output from the optical sources, an amount of light blocked by the support pin is small and the occurrence of unevenness in the brightness can be suppressed. Because the wide-width surface is formed, a certain thickness of the support pin is ensured and the high rigidity of the support pin can be ensured.

According to another embodiment of the present technology, two narrow-width surfaces are formed so as to face in opposite directions, where each of the two narrow-width surfaces is the above narrow-width surface, and the support pin is disposed between the two optical sources.

Therefore, because light output from the optical sources is blocked by the narrow-width surfaces with a narrower width in the support pin, an amount of light output from the optical sources that is blocked by the support pin is small and the occurrence of unevenness in the brightness can be further suppressed.

According to still another embodiment of the present technology, the support pin is disposed in the center between the two optical sources.

Therefore, an amount of light incident on the two narrow-width surfaces is equalized and the occurrence of unevenness in the brightness on the display can be further suppressed.

According to yet another embodiment of the present technology, a tip surface, which is part of an external surface of the support pin and located at the end on the diffuser panel side, is formed in a convex curved surface shape on the diffuser panel side.

Therefore, damage to the diffuser panel can be prevented when the support pin comes into contact with the diffuser panel, and the excellent diffusion function of the diffuser panel can be ensured.

According to still yet another embodiment of the present technology, the external surface of the support pin is formed in a curved surface shape.

Therefore, a portion with partially low rigidity is less likely to be generated in the support pin and the high rigidity of the support pin can be ensured.

### BRIEF DESCRIPTION OF THE DRAWINGS

FIG. 1 is a schematic perspective view showing, along with FIGS. 2 to 8, a display device according to an embodiment of the present disclosure;

FIG. 2 is a schematic exploded perspective view of the display device;

FIG. 3 is an enlarged plan view of a support pin;

FIG. 4 is an enlarged side view of the support pin;

FIG. 5 is a schematic front view showing a position etc. of the support pin with respect to an optical source;

FIG. 6 is a schematic diagram illustrating, along with FIGS. 7 and 8, a support pin size etc., the schematic diagram showing a distance from the optical source to the support pin and a width of a narrow-width surface;

FIG. 7 is a schematic diagram showing a length of the support pin; and

FIG. 8 is a schematic diagram showing a width of each surface of the support pin.

### DETAILED DESCRIPTION OF EMBODIMENTS

A display device according to a preferred embodiment of the present technology will be described below with reference to accompanying drawings.

A display device according to the following preferred embodiment of the present technology is applied to a television set.

The range of application of the embodiment of the present technology is not limited to the television set. The embodiment of the present technology can be widely applied to, for example, various kinds of display devices with displays for personal computers, mobile terminal devices, electronic books, and the like.

### [Configuration of a Display Device]

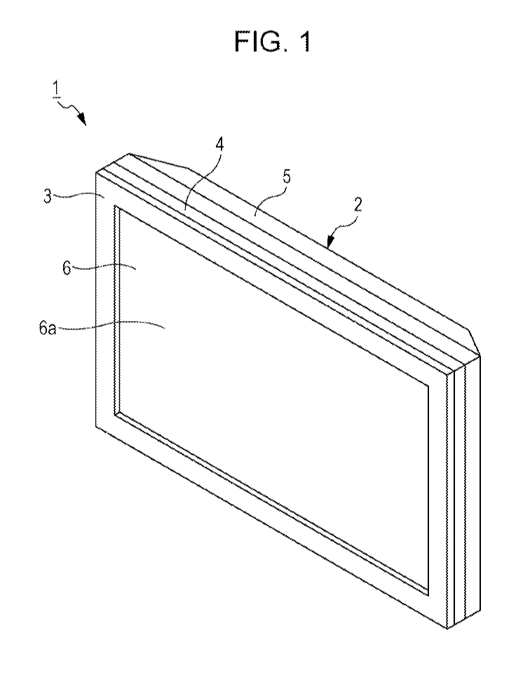

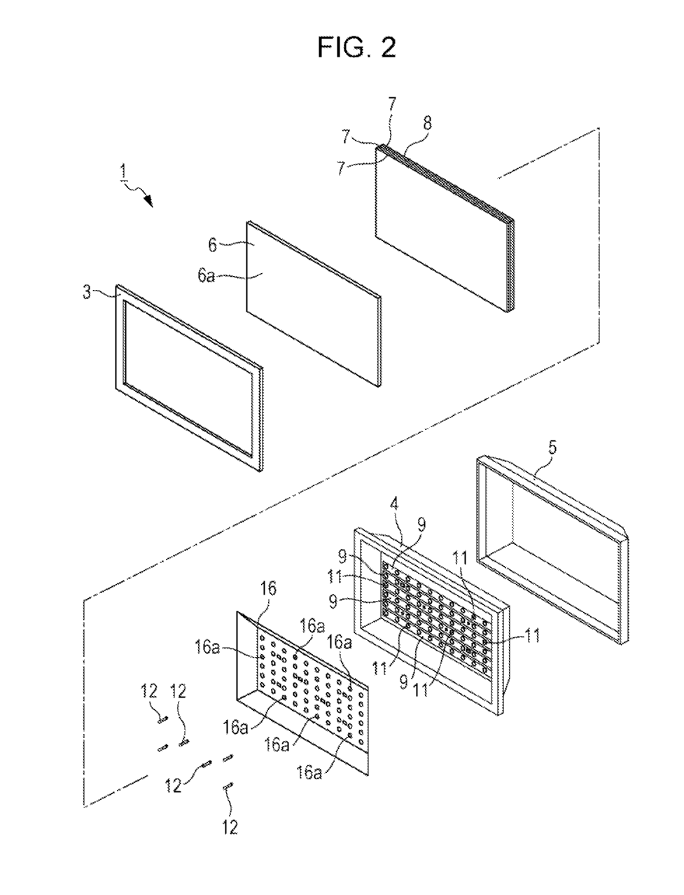

A display device 1 (for a television set) is formed, for example, in a horizontally long, flat, substantially rectangular shape, and sections to be assembled are disposed in a housing 2 (see FIGS. 1 and 2). The display device is supported by, for example, a stand (not shown).

The housing 2 has a bezel 3 disposed in the front and a back chassis 4 disposed in the rear.

The bezel 3 is formed in a substantially rectangular frame shape.

The back chassis 4 is formed in a shallow box shape with a front opening. A control board (not shown) is attached to the rear surface of the back chassis 4. The control board functions as a control circuit that performs processing such as supplying current to a display, which will be described below, and supplying drive current to an optical source, which will be described below, as well as performs overall control of the display device 1.

A rear cover 5 is attached to the back chassis 4 from the rear. The rear cover 5 is formed in a shallow box shape with a front opening and encloses the control board.

A display 6 is disposed on the inner periphery side of the bezel 3. The display 6 is, for example, a liquid crystal panel having a layered structure of a glass substrate, a polarizing sheet, and the like, and has a front surface formed as a display surface 6a on which to display images.

The display 6 is formed in a substantially rectangular shape, in which a portion other than the outer periphery is provided as a display area on which to display images and the outer periphery is supported by the bezel 3. A connection board (not shown) is provided at the bottom of the display 6 and connected to the control board attached to the rear surface of the back chassis 4.

Optical sheets 7 and a diffuser panel 8 are disposed in order from front to back in the rear of the display 6. The optical sheets 7 are disposed, for example, in a layered state in the front of the diffuser panel 8.

The optical sheets 7 have functions such as diffusion of light and control of a direction of travel of light, in order to, for example, achieve evenness in the brightness and improve the brightness on the display 6.

The diffuser panel 8 has a function of achieving evenness in the brightness on the display 6 by diffusing light output from the optical source.

Circuit boards 9, which are referred to as light sources, are, for example, attached to the front surface of the back chassis 4 so as to be vertically separated. The back chassis 4 may be configured to have an attaching part (not shown) to which the circuit boards 9 are attached.

The circuit boards 9 are formed in a horizontally long shape and connected to the control board attached to the rear surface of the back chassis 4.

Optical sources 10 are mounted on the circuit boards 9 so as to be horizontally separated. Examples of the optical sources 10 include a light emitting diode (LED). The optical sources 10 are covered by optical source covers 11, respectively.

Support pins 12 are attached to the circuit boards 9. The support pins 12 are formed of, for example, a colored resin material such as polycarbonate. The material of the support pins 12 is preferably a material that has a certain level of rigidity and resistance to discoloration (yellowing) due to light or heat.

The support pin 12 is disposed in the center between the optical sources 10 disposed so as to be horizontally separated. These optical sources 12 are at the shortest distance from the support pin 12.

The tips of the support pins 12 may come into contact with the rear surface of the diffuser panel 8. The support pins 12 have a function of maintaining the position of the diffuser panel 8 by suppressing deformation (deflection) in the diffuser panel 8.

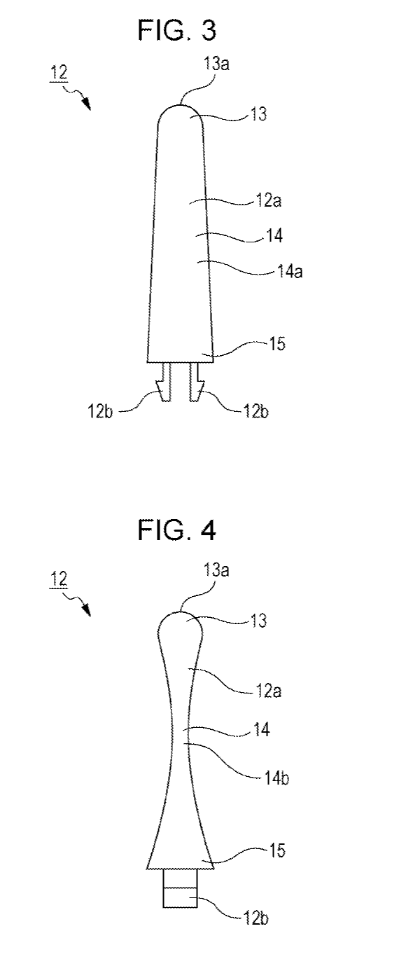

The support pin 12 is formed in a shape extending in the front-back direction of the display device 1, and an external surface 12a thereof is formed as a curved surface. The support pin 12 has a tip part 13, an intermediate part 14, and an attached part 15 provided in order from front to back (see FIGS. 3 to 5). The support pin 12 has engagement hooks 12b protruding rearward from the attached part 15.

The tip part 13 is formed in a substantially hemispherical shape, and a tip surface 13a, which is part of the external surface, is formed in a convex curved surface shape on the diffuser panel 8 side.

The intermediate part 14 is formed in a shape having different widths in two directions perpendicular to an alignment direction (front-back direction) in which the display 6 and the diffuser panel 8 are aligned; the intermediate part 14 has wide-width surfaces 14a and narrow-width surfaces 14b having a width narrower than that of the wide-width surfaces 14a. The wide-width surface 14a is formed in a shape in which the width increases slightly toward the rear (see FIG. 3). The narrow-width surface 14b is formed in a shape in which the width is the narrowest in the center in the axis direction (front-back direction) and becomes wider toward the front and rear from the center (see FIG. 4).

The attached part 15 is the rear end of the support pin 12 and attached to the circuit boards 9.

As described above, the tip surface 13a of the support pin 12 is formed in a convex curved surface shape on the diffuser panel 8 side. Accordingly, damage to the diffuser panel 8 can be prevented when the support pin 12 comes into contact with the diffuser panel 8, and the excellent diffusion function of the diffuser panel 8 can be ensured.

Moreover, as described above, the external surface 12a of the support pin 12 is formed in a curved surface shape. Accordingly, a portion with partially low rigidity is less likely to be generated in the support pin 12 and the high rigidity of the support pin 12 can be ensured.

The support pin 12 is attached to the circuit board 9 with the narrow-width surfaces 14b oriented in a horizontal direction when the engagement hooks 12b are engaged in engagement holes (not shown) formed in the circuit board 9. In this way, the support pin 12 is attached to the circuit board 9 with the narrow-width surfaces 14b oriented in a horizontal direction, and therefore the narrow-width surfaces 14b face the right and left optical sources 10 at the shortest distance, respectively. The support pin 12 is disposed in the center between the optical sources 10.

When the support pin 12 is attached to the circuit board 9, the tip part 13 is disposed so as to abut against or come close to the rear surface of the diffuser panel 8.

A reflective sheet 16 is disposed in the front of the back chassis 4. Placement holes 16a are formed in the reflective sheet 16 so as to be vertically and horizontally separated. When the reflective sheet 16 is disposed in the front of the back chassis 4, the optical sources 10 and the support pins 12 are inserted and disposed in the placement holes 16a, protruding frontward from the front surface of the reflective sheet 16.

### [Output of Light in the Display Device]

In the display device 1 configured as described above, when light is output from the optical sources 10, the light is diffused by the diffuser panel 8 and incident on the display 6 as backlight. In this case, part of the light output from the optical sources 10 is reflected by the reflective sheet 16 and incident on the display 6 via the diffuser panel 8.

When light is output from the optical sources 10, part of the light reaches the support pins 12 and is blocked by the support pins 12. Because the narrow-width surfaces 14b of each support pin 12 face the right and left optical sources 10 at the shortest distance, respectively, an amount of light blocked by the support pins 12 is small.

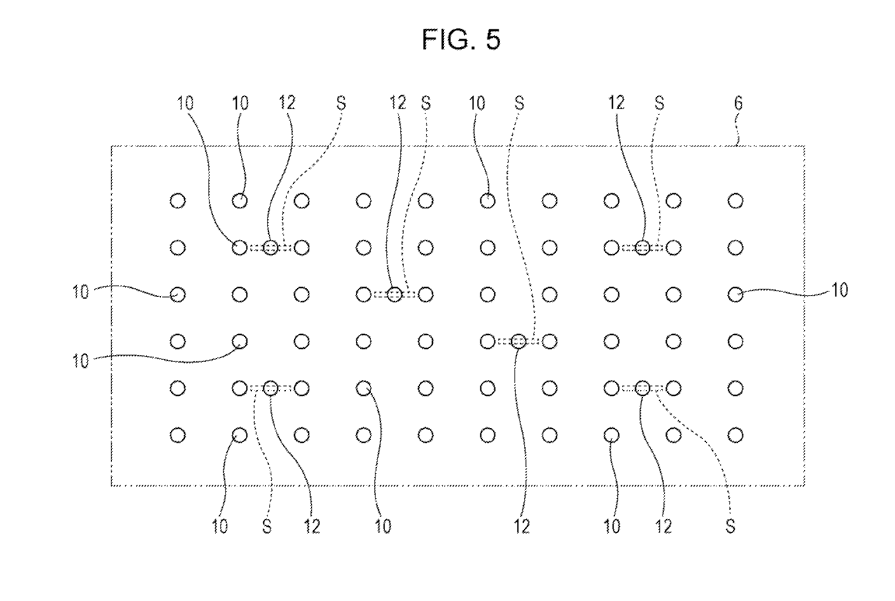

The support pin 12 is disposed between the right and left optical sources 10, and therefore thin shadows S are formed and extend horizontally on the display 6 because the light is blocked by the support pin 12. It is less likely that a plurality of linear shadows cross, and unevenness due to the shadows is less noticeable when the display 6 is viewed (see FIG. 5).

Therefore, partial differences in the brightness on the display 6 are less likely to occur, and the occurrence of unevenness in the brightness is suppressed.

### [Sizes etc. of the Support Pins and Others]

It is preferable that the size of each support pin or the like is as follows in order to suppress the occurrence of unevenness in the brightness.

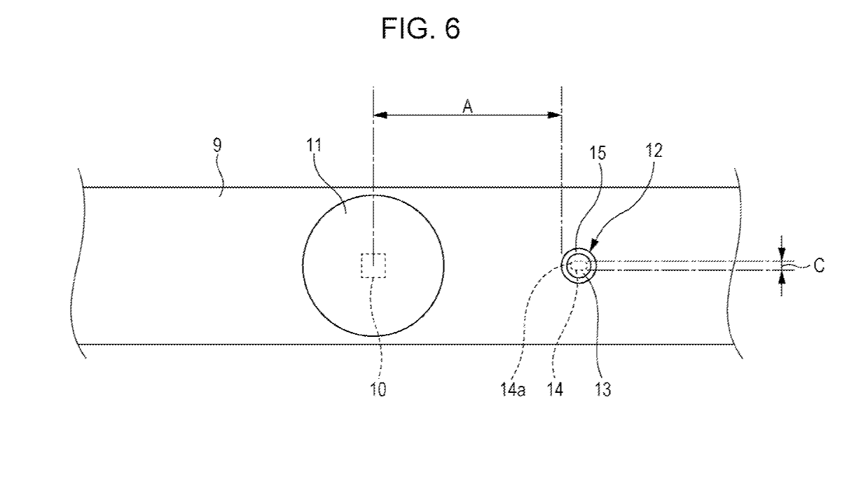

As shown in FIG. 6, when A denotes the distance from the center of the optical source 10 to the support pin 12 and C denotes the minimum width of the narrow-width surface 14b of the support pin 12, it is preferable that C/A is 20% or less.

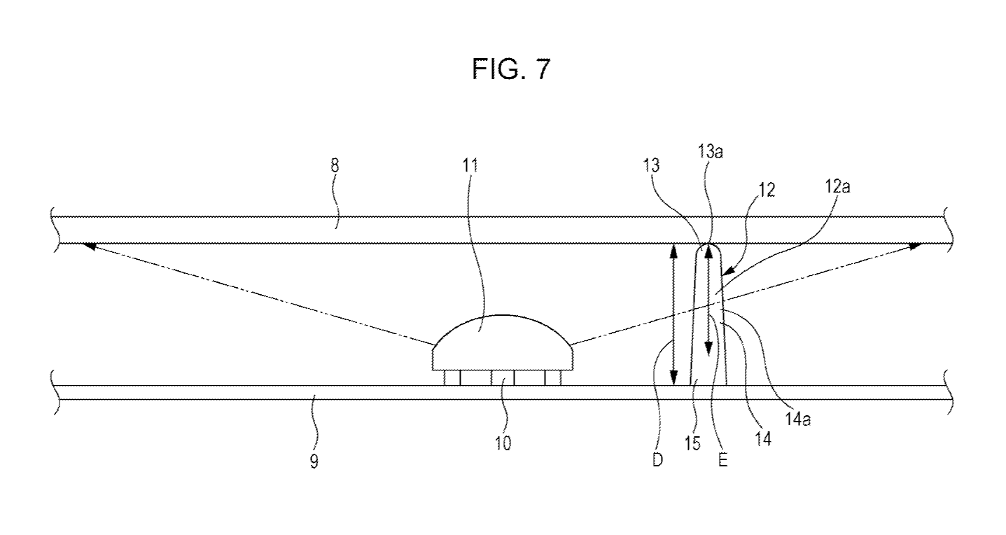

In addition, as shown in FIG. 7, when D denotes the length of the support pin 12 and E denotes the length from the tip of the portion of the support pin 12 in which the width is narrower, it is preferable that E/D is 80% or more.

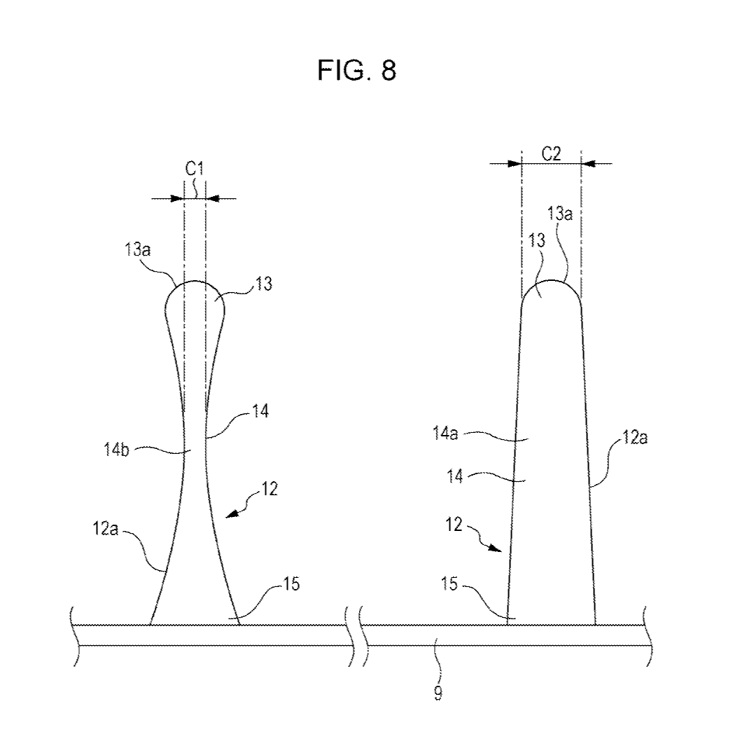

Moreover, as shown in FIG. 8, when C1 denotes the minimum width of the narrow-width surface 14b and C2 denotes the minimum width of the wide-width surface 14a, it is preferable that C1/C2 is 95% or less.

### [Conclusion]

As described above, in the display device 1, the support pin 12 has the wide-width surface 14a and the narrow-width surface 14b that differ in width in two directions (vertical and horizontal directions) perpendicular to an alignment direction (front-back direction) in which the display 6 and the diffuser panel 8 are aligned. The narrow-width surface 14b faces the optical source 10 at the shortest distance.

Therefore, when light is output from the optical sources 10, an amount of light blocked by the support pin 12 is small and the occurrence of unevenness in the brightness can be suppressed. Because the wide-width surface 14a is formed, a certain thickness of the support pin 12 is ensured and the high rigidity of the support pin 12 can be ensured.

In addition, in the display device 1, the support pin 12 is disposed between the two optical sources 10.

Therefore, because light output from the optical sources 10 is blocked by the narrow-width surfaces 14b with a narrower width in the support pin 12, an amount of light output from the optical sources 10 that is blocked by the support pin 12 is small and the occurrence of unevenness in the brightness can be further suppressed.

Moreover, because the support pin 12 is disposed in the center between the optical sources 10, an amount of light incident on the narrow-width surfaces 14b is equalized and the occurrence of unevenness in the brightness on the display 6 can be further suppressed.

### [Embodiment of the Present Technology]

The embodiment of the present technology can adopt the following configuration.

(1) A display device including a display with a display surface on which to display images, a plurality of optical sources that act as a backlight to output light to the display, a diffuser panel that is disposed so as to face the plurality of optical sources and diffuses the light output from the optical sources, and a support pin that is disposed on the side opposite to the display across the diffuser panel, is contactable with the diffuser panel, and maintains the position of the diffuser panel, wherein the support pin has a wide-width surface and a narrow-width surface that differ in width in two directions perpendicular to an alignment direction in which the display and the diffuser panel are aligned, the plurality of optical sources and the support pin are disposed alongside in a direction perpendicular to the alignment direction, and the narrow-width surface of the support pin faces the optical source at the shortest distance.

(2) The display device described in (1) above, wherein two narrow-width surfaces are formed so as to face in opposite directions, where each of the two narrow-width surfaces is the above narrow-width surface, and the support pin is disposed between two optical sources.

(3) The display device described in (2) above, wherein the support pin is disposed in the center between the two optical sources.

(4) The display device described in any one of (1) to (3) above, wherein a tip surface, which is part of an external surface of the support pin and located at the end on the diffuser panel side, is formed in a convex curved surface shape on the diffuser panel side.

(5) The display device described in (1) above, wherein the external surface of the support pin is formed in a curved surface shape.

It should be understood that the specific shapes and structures of the sections described in the above preferred embodiment of the present technology are merely examples of embodiments in implementing the present technology and are not meant to limit the technical scope of the present technology in any way.

The present disclosure contains subject matter related to that disclosed in Japanese Priority Patent Application JP 2012-160206 filed in the Japan Patent Office on Jul. 19, 2012, the entire contents of which are hereby incorporated by reference.

What is claimed is:

1. A display device comprising:
a display with a display surface on which to display an image;
a plurality of optical sources acting as a backlight to output light to the display;
a diffuser panel disposed so as to face the plurality of optical sources, the diffuser panel diffusing the light output from the optical sources; and
a support pin disposed on a side opposite to the display across the diffuser panel, the support pin being contactable with the diffuser panel and maintaining a position of the diffuser panel, wherein
the support pin has a wide-width surface and a narrow-width surface that differ in width in two directions perpendicular to an alignment direction in which the display and the diffuser panel are aligned,
the plurality of optical sources and the support pin are disposed alongside in a direction perpendicular to the alignment direction, and
the narrow-width surface of the support pin faces the optical source at a shortest distance.

2. The display device according to claim 1, wherein
two narrow-width surfaces are formed so as to face in opposite directions, each of the two narrow-width surfaces being the above narrow-width surface, and
the support pin is disposed between two optical sources.

3. The display device according to claim 2, wherein
the support pin is disposed in a center between the two optical sources.

4. The display device according to claim 1, wherein
a tip surface, which is part of an external surface of the support pin and located at an end on a diffuser panel side, is formed in a convex curved surface shape on the diffuser panel side.

5. The display device according to claim 1, wherein
the external surface of the support pin is formed in a curved surface shape.
